(19) United States
(12) Patent Application Publication
(10) Pub. No.: US 2004/0098494 A1
(43) Pub. Date: May 20, 2004

(54) Method and system for telecommuting enviroment

(76) Inventor: Tauno Mikkulainen, Ulvila (FI)

Correspondence Address: MERCHANT & GOULD PC, P.O. BOX 2903, MINNEAPOLIS, MN, 55402-0903, US

(21) Appl. No.: 10/363,353

(22) PCT Filed: Sep. 10, 2001
(86) PCT No.: PCT/FI01/00785

(51) Int. Cl. G06F 15/16

(52) U.S. Cl. 709/229; 709/203; 709/246; 709/249

(57) ABSTRACT

The invention relates to a method and system for working in a distributed working environment which comprises a terminal device (DTE) equipped with a client program and a server (SERV) equipped with a server program, the server being connected via a telecommunication network (CN) to the terminal device (DTE). In the method, information is being transmitted from the terminal device (DTE) to a multidimensional work platform on the server (SERV), and information is being transmitted from a multidimensional work platform on the server (SERV) to the terminal device (DTE).

The invention relates to telecommunication systems. In particular, the invention relates to a method and system that comprise a terminal device comprising a client program and a server comprising a server program. In the method, information is being transmitted between the terminal device and the server by using a multidimensional work platform.

### PRIOR ART

With the present rapid development of information technology, more and more efficient and better working methods are being looked for. With the national and international operations of companies, the meaning of different distributed working environments is more emphasized, since more and more employees travel a lot. Distributed working environments may also offer new possibilities for a working environment, such as working in a holiday house in a pure climate and nature.

Typically, a distributed working environment consists of a computer which is connected either via a mobile station or a fixed telephone network to a telecommunication network, such as e.g. the Internet. Depending on the work task, the computer comprises the most general software, such as e-mail programs and word processing programs. The interactivity of the working environment is often enhanced by an Internet browser program which enables one to send or receive information around the world, e.g. from the head office.

One specific problem is becoming the telecommuting of work teams. Usually work teams work by holding an ideation meeting. In the meeting, ideas are being written down in A4-sized pieces of paper, which are attached to a wall for the appraisal of the ideas. In the appraisal, each employee can give points to the ideas, whereby the best ideas may be further developed. The above-mentioned holding of ideation meetings between several distributed places of duty is cumbersome, since there is no solid wall into which each employee could write their notes.

Previously known is no solution to the aforementioned problems. Usually employees have traveled e.g. by aeroplane long distances to a common meeting. The above-mentioned is both expensive and time-consuming. On the other hand the employees have been able to use ISDN video conferencing systems. The use of the systems is, however, expensive, and also the resolution of a video image is small. In that case, no proper image of the ideation notes pinned to the wall is transmitted to a distributed working environment, which makes it more difficult to hold a meeting.

A solid wall may be imitated by sending an e-mail consisting of several pages to the relevant people. The e-mail may be divided into parts in order to address different subjects. The parts may be commented by adding text to a desired point. When using e-mail all the people concerned have their own copy of the work file. In editing, revisions are done solely in one's own copy, which is sent to the people concerned. In case somebody else is doing changes at the same time, the changes do not end up in the same copy, instead the people concerned shall follow several copies. Furthermore, owing to the nature of e-mail systems, it is possible that the sent e-mail does not reach all the relevant people. The messages may be left pending on the mail server, or when responding one may by negligence reply only to the sender of the message and not to all recipients. In addition, when using the e-mail a lot of messages are created. A big number of messages increases the traffic, and from a big number of messages it is difficult to pick out the important messages from the less important ones.

Peter Parnes has handled a team work system in his licentiate's dissertation mStar Environment—Scalable Distributed Teamwork using IP Multicast. One part of the system is concerned with a means similar to a solid wall that has been implemented by drafting a document. In the document, on each page goes only a limited amount of information. The pages may be commented by creating layers on the pages at which the comments are placed.

All the people concerned have their own copies of the work files, and the made changes are distributed using IP multicast or a separate transmission component. A problem is becoming the amount of telecommunication traffic as well as fault situations of a telecommunication network, in which case the changes do not necessarily reach all the relevant people. The access rights may be allocated by layers. A layer is shown only if the user's access rights are sufficient for it. In each layer, one comment is stored, so when all the layers can been seen, also the comments can be read. The problem with this kind of system is the uniformity of the comments. In case there are layers created in between for which the user's rights are not sufficient, the understanding of later comments may get more difficult. This is what happens especially in those cases in which commentaries are given to all and reference is made to layers that everybody cannot see. Owing to the one-dimensional nature of the system, the pages are not necessarily associated with one another, and it is difficult to get a picture of the whole, if the provider does not actively group the pages under separate entities.

The objective of the present invention is to eliminate or alleviate the problems referred to above. One further objective of the invention is to enable a considerably easy-to-use method for holding a quick and advantageous meeting between several employees who are located geographically far from one another. On the other hand the invention does not require a simultaneous communication between the employees except for special occasions, e.g. a telephone conference or other corresponding situation. SUMMARY OF THE INVENTION

The invention enables one to create a virtual distributed working environment in which the employees can meet and solve problems related to work tasks easily, rapidly and advantageously.

The invention relates to a method in which one works in a distributed working environment which at its simplicity comprises a terminal device comprising a client program, a server comprising a server program, and a telecommunication connection by which the server and the terminal device are connected. In this application, one speaks generally about a terminal device, the rights connected with it, etc. However, it must be noted that the terminal device is just a physical means by which the user participates in a session or working in a distributed environment, i.e. reads or edits a view to be displayed to the user.

In the method, a connection is established between the terminal device and the server. For the connection set-up, it is possible to use a public or a dedicated information network, and when necessary the connection is encrypted. Further, in the method, information is transmitted from the terminal device to a multidimensional work platform on the server, and information is transmitted from the multidimensional work platform on the server to the terminal device. The editing and processing of the information is done on the server by a executable program code. In the same way also the functions related to the work platforms are performed on the server by a executable program code. The server system may be distributed, in which case for each function, a server of one's own is used, e.g. an application server, WWW server, file server, e-mail server, and a database server. In small systems, all may be located on physically one server. In the servers, general solutions may be used, but they may be substituted with a system specifically adapted to the function, e.g. a WWW server equipped with a specific server fit for the transmission of views for which one gets registered by means of a client program of one's own.

Upon logging into the system, the user is authenticated, and his/her user profile is loaded. Stored in the profile is a level of access rights, which is in a way view-specific, i.e. in different sessions, the user may be either a chairman or a participant, a piece of information about the work platforms to which the user was granted an access and a piece of information containing the state of the work platforms. The state information of the work platforms comprises e.g. a piece of information on unread messages. The user profile may also comprise other information.

In one embodiment of the invention, the information to be transmitted is text-formed information. On the other hand it is also possible to transmit image-formed information or multimedia information.

In one embodiment of the invention, boxes are used on the platform into which it is possible to store information using a terminal device. Typically, the information is a text-formed written idea relating to a meeting. On the other hand at the bottom of the work platform there may also be boxes from which it is possible to only read information. It is also possible to lock parts of the information in the box, such as e.g. the preamble or a certain comment, in which case they may not be changed any longer. The locking may be done also for the whole work platform or any part of the work platform, such as a box.

In one embodiment of the invention, in the boxes of the work platform of the server, messages are stored that the other users of the server may read. A browser program consistent with the Internet or wireless application protocol (WAP, Wireless Application Protocol) is often used in the terminal device.

In one embodiment of the invention, information between the terminal device and the server is transferred using the e-mail. Typically, in an e-mail message, a piece of reference information, a reference or a code may be used by means of which the server automatically performs a function. A typical function is the establishing of a new session using the e-mail. The future chairman of a new session sends a subject to be addressed by e-mail to the server, which establishes a session and sends a message thereof provided with a link to all the participants. Another example could be the delivering of a report of a meeting automatically to the participants of the meeting without the sender of the message having the e-mail addresses of the participants of the meeting.

In one embodiment of the invention, a level of access rights is defined to the terminal device.

Usually it is advantageous to use three levels of access rights. The highest level is a chairman level of access rights, in which case the distributed work platform is managed by the terminal device or by the user, there are determined the terminal devices or users participating in the working, there are determined the ownership of the box and the reading and writing rights, and there are determined the function of the work platform and the number of horizontal and vertical lines of the work platform. With the chairman rights one can also use an automatic reporting, in which case the system draws a conclusion of the work platform. The next level is a level of participant access rights, in which case one works with the terminal device as one participant, one sees also other work platforms belonging to the terminal device, one may take an automatic report of the information of the work platform and one may establish new work platforms. As the lowest level, a level of specialist rights is used, in which case the terminal device has access only to the work platform belonging to the terminal device, one can read the work platform or write in the work platform. The number of the levels of access rights can be changed according to practical need. The content of the work platform may be locked, in which case only the owner of the content has the right to edit, while the others only have the right to read. The locking may applied to the whole work platform or separate parts of the work platform.

In one embodiment of the invention, one may use the e-mail for editing the work platform. The e-mail is used, among other things, for the scheduling of the operation between the terminal devices participating in the work platform as well as for other communication. The e-mail may be used to transmit all the commands related to the system, such as establishing sessions, asking for reports, and summoning the users to a session. As the e-mail program, a separate program or an e-mail integrated into the client program of the system may be used, in case a separate client program is used.

In one embodiment of the invention, in addition to a normal piece of title information and information, a box of the work platform is provided with a link to a second work platform. This makes it possible to restrict a link attached to the work platform to concern only those terminal devices or users who have access to the work platform in question. Usually it is allowed for just one terminal device at a time to edit the content of the box. On the other hand several terminal devices may read the same box at the same time. It is also possible to attach attachment files to the boxes. Typically, the piece of information on the attachment files is placed separately from the information part, but the attachment files may also be placed among the other information.

It is possible to vote about the hierarchy of the boxes. For voting, a voting field is attached to each box. Typically, changing of the boxes in a voting situation is prevented. On the other hand it is also possible to prevent the other terminal devices from seeing the voting information of the boxes in a voting situation.

In one embodiment of the invention, information is sent on the use of the boxes. This makes it possible to monitor the progressing of the work. By sending control e-mail messages from the terminal device, the work platform is advantageously controlled. It is also possible to receive printing e-mail messages sent from the work platform onto the terminal device. To each e-mail control function, an unambiguous e-mail address is attached that determines the function to be performed. For example, the rights of the sender's work platform may be determined based on the sender field of the e-mail.

The terminal device or a participant in the session is summoned to a work platform working by sending an e-mail which comprises the link address of the work platform. The terminal device starts up a long-distance working by following the link address. On the other hand it is possible to control the work platform by means of the menu of the terminal device.

The system for working in a distributed working environment comprises a terminal device which comprises a client program, and a server which comprises a server program, the server being connected to the terminal device. Further, the system comprises means for using on the terminal device a two-dimensional work platform being present on the server, means for generating a multidimensional work platform, and means for editing a multidimensional work platform from long distance.

In one embodiment of the invention, the system comprises means for sending the work platform to an Internet terminal device. On the other hand the system may also comprise means for sending the work platform to a WAP terminal device. Further, the system may comprise means for receiving a control e-mail message, means for performing a function comprising the control e-mail message, and means for compiling a feedback on the control function and for sending it to the terminal device.

The advantage of the invention over prior art is that a company's employees may hold a meeting without the people being located physically in the same place. In that case, savings are made on the travel costs of the employees, since the employees need to travel less. Further, no time is wasted on travelling and on the other hand the employees may participate in discussion while travelling. The employees may also work at different times, because the solution in accordance with the invention does not require a simultaneous presence of the employees except for special occasions, such as e.g. a telephone conference. Also time is saved because the time of the employees is not wasted on travelling. Therefore, considerable savings are made, if we compare the invention to the previous systems of holding a meeting. Remarkable is also the fact that one may work in real-time independent of time and place, in which case the circulation of information between different employees is fast and efficient.

### LIST OF DRAWINGS

In the following section, the invention will be described by the aid of the accompanying examples of its embodiments with reference to the accompanying drawing, in which

FIG. 1 represents one system illustrating the system of the invention;

FIG. 2 is a flow chart illustrating the method of the invention;

FIG. 3 represents one work platform of the invention;

FIG. 4 represents one embodiment of the invention;

FIG. 5 represents one system of the invention; and

FIG. 6 represents one embodiment of the invention.

### DETAILED DESCRIPTION OF THE INVENTION

At its simplicity, the invention comprises a terminal device equipped with a client program, a server program equipped with a server program, and a telecommunication connection by which the server and the terminal device are connected. As the client program it is most advantageous to use a WWW browser to which an e-mail is attached. When using the working environment it is possible to send e-mail or visitor invitations from the program using a WWW browser, but in that case the server takes care of the sending of the messages, i.e. it is actually not a question about an e-mail connected to a browser. As the server program it is most advantageous to use a WWW server or an HTTP server to which a possibility of driving program codes is added. In addition, added to the system is a database that the program codes use for storing and reading data. In the method, a connection is established between the terminal device and the server. For establishing the connection, it is possible to use a public or a dedicated data network, and when necessary the connection is encrypted. The encryption may be implemented either symmetrically or asymmetrically. An asymmetric e-mail is typically used for encrypting e-mail reports, in which case the public key of the user shall be stored in the user profile. Also all the user-specific information of the session is stored in the user profile.

In the method, information is transmitted from the terminal device to a multidimensional work platform on the server and information is transmitted from a multidimensional work platform on the server to the terminal device. The editing and processing of the information is done on the server by a executable program code. In the same way also the functions related to the work platforms are performed on the server by a executable program code. The server system may be distributed, in which case for each function, a server of one's own is used, e.g. an application server, WWW server, file server, e-mail server, and a database server. In small systems, all may be located on physically one server.

In the servers, general solutions may be used, but they may be substituted with a system specifically adapted to the function, e.g. a WWW server equipped with a specific server fit for the transmission of views for which one gets registered by means of a client program of one's own.

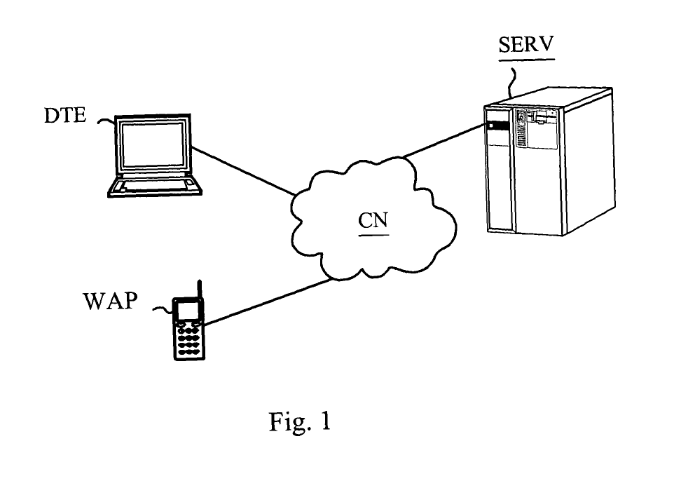

FIG. 1 represents one system in accordance with the invention. The terminal device DTE of the system is connected via a telecommunication network CN to the server SERV. Usually as the telecommunication network CN, the Internet is used. In one advantageous embodiment of the invention, a WAP terminal device WAP is used as the terminal device. From the WAP terminal device WAP there is a connection arranged via the telecommunication network CN to the server SERV. In that case, as the telecommunication network CN, the global system for mobile communications is usually used.

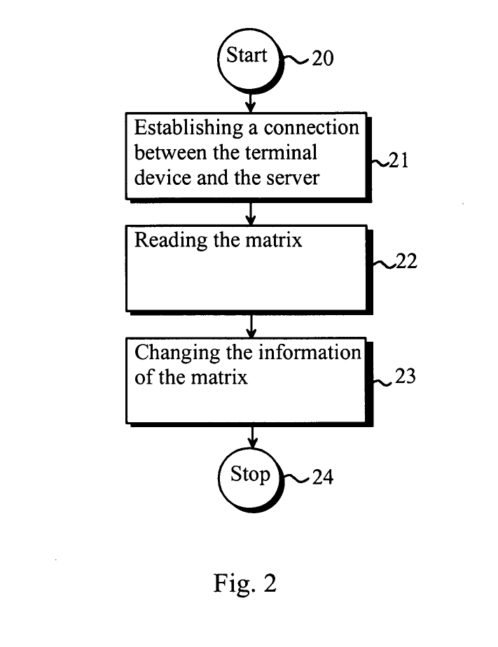

FIG. 2 is a diagram illustrating the method of the invention. At first, a connection is established between the terminal device DTE and the server SERV, block 21. Next, the work platform on the server SERV is read and transferred to the terminal device DTE, block 22. The information of the work platform may be changed and the changed information may be transmitted box by box back to the server SERV, in which case the other distributed workers see the changes.

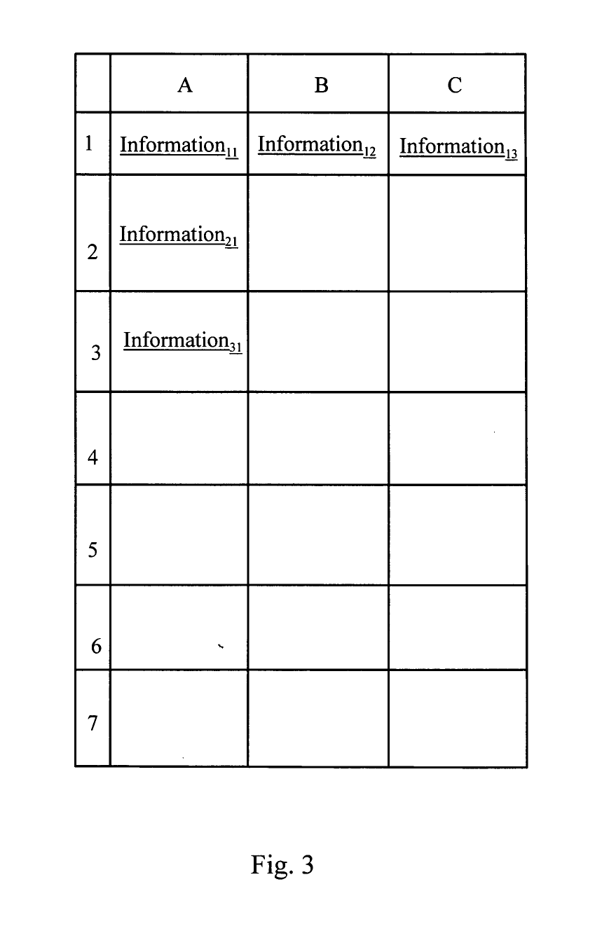

FIG. 3 represents one work platform in accordance with the invention. The work platform of the figure consists of three vertical columns A, B, C and seven horizontal lines 1-7. It is possible to save information to the boxes of the work platform. Saved to the five boxes of the work platform of the figure are e.g. planning ideas to be handled in an ideation meeting. The boxes Tieto₁₁, Tieto₁₂, Tieto₁₃ of the first line may comprise the name information of the participants of the meeting. To the following box Tieto₂₁ it is possible to save the goals of the meeting, and to the box Tieto₃₁, the first preliminary idea is saved. If one proceeds like this, an analyzed whole is formed on the work platform that helps systematic documentation and systematized working. Often the system is used from several terminal device simultaneously, in which case the information of the work platform is updated in real time. The solution of the invention is not defined to a particular platform size, instead the dimensions of the work platform are optional.

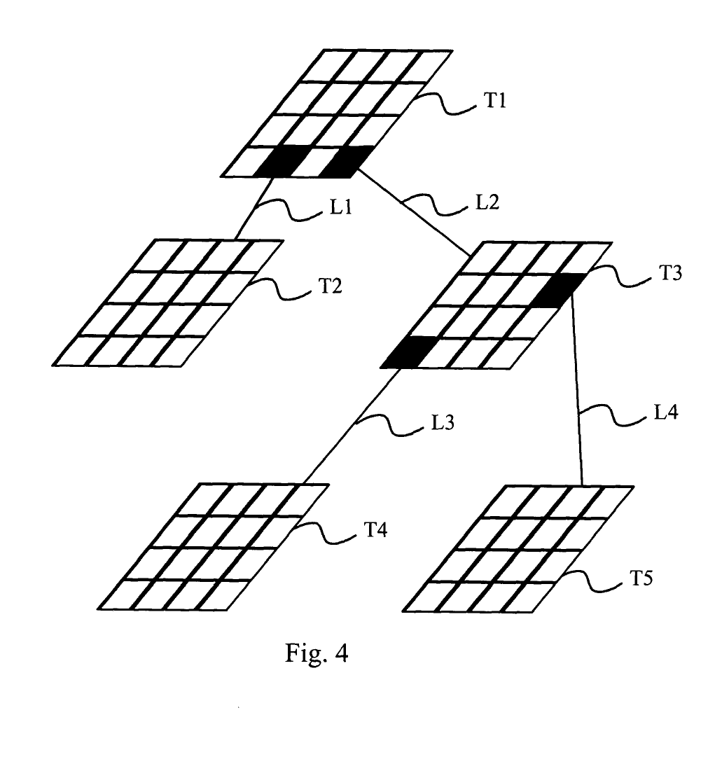

FIG. 4 represents one embodiment in accordance with the invention. The embodiment comprises a multidimensional work platform to which one gains access by two-dimensional views T1, T2, T3, T4 and T5, which are connected to one another by five links L1, L2, L3, L4 and L5. From the first view T1 there is a connection to view T2 via the link L1 attached to the box. Correspondingly, there is a connection from view T2 to view T1 from the box via the second link L2. It is important that each view can have individual terminal devices, i.e. users. Therefore, the first terminal device can handle view T1 but cannot handle view T2. The view to the work platform is thus individual for each terminal device or user. On the other hand the whole of the matters may considerably change, if a person is added as a participant to a separate session. Correspondingly, unambiguous terminal devices may be attached to the links. In that case, only those terminal devices that have got a permission to use the links may proceed via the link to a second view. As a whole, the views form a structure which describes the connections between the matters and about which one may read only the matters that concern the terminal device. Therefore, as participants of each view can function a different set of terminal devices, in which case a totally novel method has been implemented for managing handling processes under the responsibility of individuals and groups and the whole formed of them. In this implementation, each individual gets a figure corresponding to their own area of responsibility of the whole formed of the processes of handling the matter.

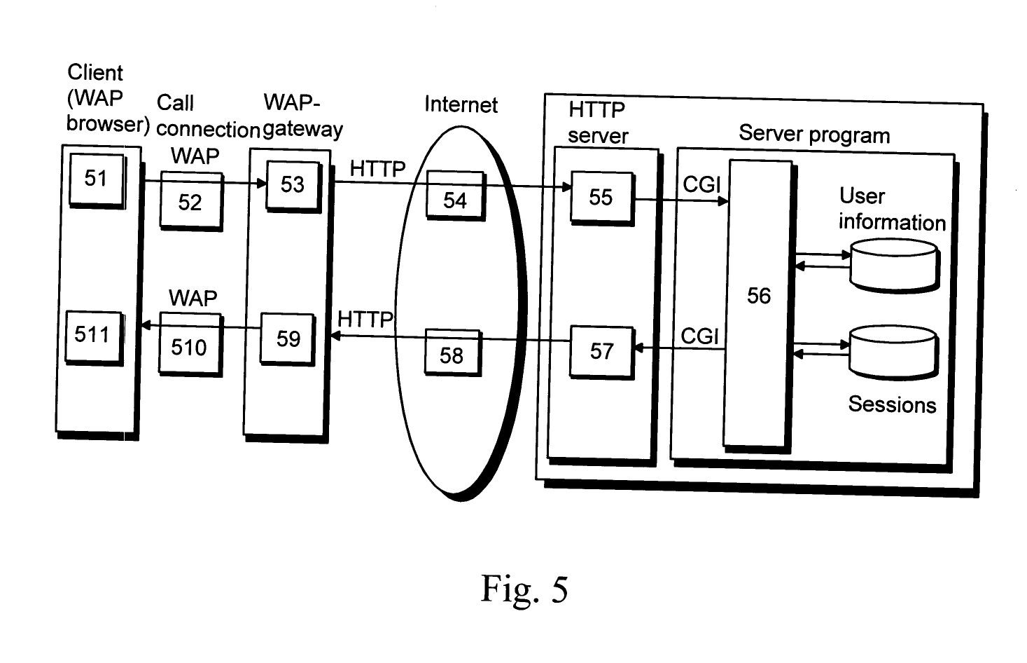

FIG. 5 describes one system in accordance with the invention in which one gains access to the work platform using a WAP browser 51 of a wireless terminal device. The WAP browser is used to establish a call connection 52 to the server, which functions as a WAP gateway (WAP-gateway) 53. The WAP gateway routes the traffic via a public network 54 to an HTTP server 55. The HTTP server communicates with a server 56 that maintains the work platforms. The server 56 creates the work platforms by a program code to be performed on the server. The generated platform is transmitted to an HTTP server 57. The steps 55 and 57 may be implemented on the same server, but the function of the system does not require it. The server 57 transmits the information over a public network 58 to the server, on which the WAP gateway 59 transmits the information to a browser 511 of a wireless terminal device using a return channel 510 of the call connection. The connections 52, 54, 58 and 510 may be encrypted.

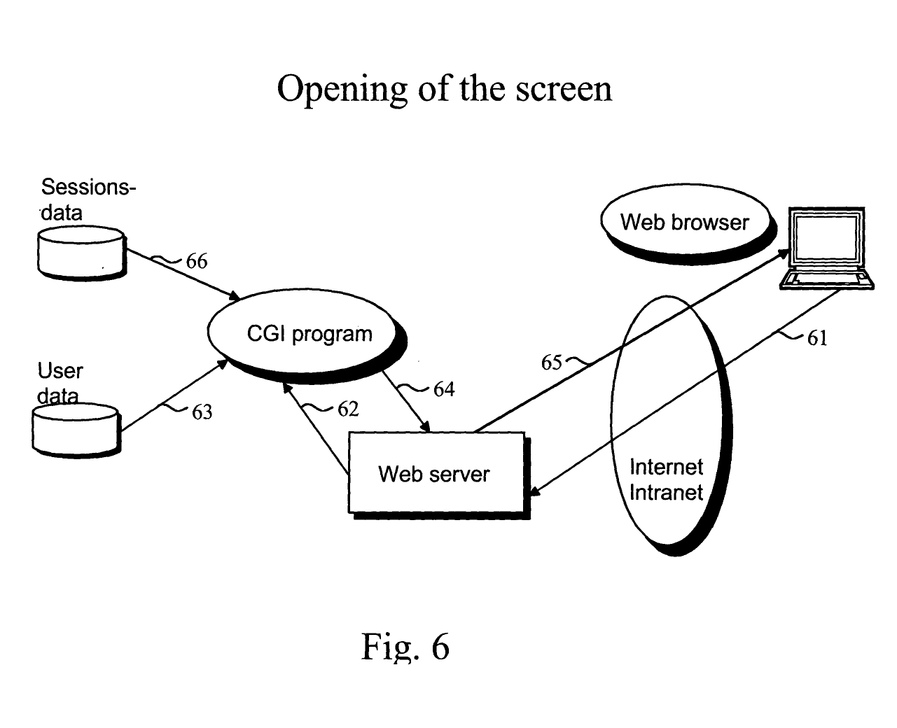

FIG. 6 represents one embodiment of the invention in which one connects to the system by means of a terminal device connected to the data network. In the embodiment, a connection 61 is established between the terminal device and a WWW or an HTTP server. The connection 61 may also be established by way of a public or a dedicated network. The WWW server establishes a connection 62 to an application server on which program codes of the application are driven. From the application server, a connection 63 is established to a database from which the user information is retrieved. The application server responds to the WWW server by establishing a return connection 64. The WWW server responds to the terminal device by establishing a return connection 65. When the return connections have been established, a connection 66 is established to the database for retrieving the session information. The session information is transmitted by means of the established connections. All the established connections may be encrypted.

The invention is not restricted merely to the examples of its embodiments referred to above, instead many variations are possible within the scope of the inventive idea defined by the claims.

1. A method for working in a distributed working environment which comprises:
a terminal device equipped with a client program and
a server equipped with a server program, the server being connected by way of a telecommunication network to the terminal device, said method comprising the steps of
establishing between the terminal device and the server,
logging into the information system located in the server;
processing and transmitting information from a multidimensional work platform stored in a database on the server to the terminal device;
editing the information placed on the multidimensional work platform, and
transmitting information in real time from the terminal device to the multidimensional work platform on the server.

2. A method according to claim 1, wherein the information to be transmitted is text-formed, image-formed and/or multimedia information.

3. A method according to claim 1, wherein the information to be transmitted is a multidimensional work platform and/or link to the information.

4. A method according to claim 1, wherein on the work platform, boxes are used to which it is possible to save information.

5. A method according to claim 1, wherein on the work platform, boxes are used from which information is read.

6. A method according to claim 1, wherein messages are saved in real time to the boxes of the work platform of the server.

7. A method according to claim 1, wherein in the terminal, an Internet browser program or a WAP browser program is used.

8. A method according to claim 1, wherein for the transfer of information between the terminal device and the server, the e-mail messages are used.

9. A method according to claim 1, wherein for the transfer of information between the terminal device and the server, an HTTP protocol is used.

10. A method according to claim 1, wherein a level of access rights is defined to the terminal device.

11. A method according to claim 1, wherein the method further comprises the steps of:
defining a chairman level of access rights to the terminal device, in which case the terminal device is used to manage the work platform;
defining the terminal devices participating in the working;
defining the ownership of a box, reading and writing right; and
defining the operation of the work platform, and the number of horizontal and vertical lines of the work platform.

12. A method according to claim 1, wherein a participant level of access rights is defined to the terminal device, in which case one uses the terminal device to work as one participant on the work platform, sees the other work platforms belonging to the terminal device, and the terminal device has the right to establish new work platforms.

13. A method according to claim 1, wherein a specialist level of access rights is defined to the terminal device, in which case one sees with the terminal device the work platform belonging to the terminal device, may read the work platform or write into the work platform.

14. A method according to claim 1, wherein the e-mail is used for the scheduling of the operation between the terminal devices participating in the work platform as well as for other communication.

15. A method according to the any one of claim 1, wherein in addition to the normal title information and other information, a box of the work platform is provided with a link to a second work platform.

16. A method according to claim 1, wherein a link attached to the work platform is restricted to concern only those terminal devices that have been granted access to the work platform in question.

17. A method according to claim 1, wherein only one terminal device at a time is allowed to edit the content of the box.

18. A method according to claim 1, wherein several terminal devices are allowed to simultaneously read the same box.

19. A method according to any of claim 4, wherein the terminal device is used to vote a hierarchy for each box of the work platform.

20. A method according to the claim 4, wherein a voting field is attached to each box for the voting by means of the terminal device.

21. A method according to claim 19, wherein the changing of the boxes in a voting situation is prevented.

22. A method according to claim 19, wherein in a voting situation, the other terminal devices are prevented from seeing the voting information.

23. A method according to claim 4, wherein information is collected on the use of the boxes.

24. A method according to claim 1, wherein the work platform is controlled by sending an e-mail message from the terminal device to the work platform.

25. A method according to claim 1, wherein a printing e-mail message sent from the work platform is received onto the terminal device.

26. A method according to claim 1, wherein to each e-mail control function, an unambiguous e-mail address consistent with the function is attached.

27. A method according to claim 1, wherein the rights of the work platform of the sender are determined based on the sender field of the e-mail.

28. A method according to claim 1, wherein the terminal device is summoned to a platform working by sending an e-mail message that comprises the link address of the work platform.

29. A method according to claim 1, wherein the work platform is controlled by means of the menu of the terminal device.

30. A method according to claim 1, wherein the multidimensional work platform is edited by means of a two-dimensional user interface.

31. A method according to claim 1, wherein the connection between the terminal device and the server is encrypted.

32. A method according to claim 4, wherein a new work platform is created in a box of the work platform.

33. A method according to claim 32, wherein the work platform is protected by user rights.

34. A method according to claim 32, wherein a separate box is protected by user rights.

35. A method according to claim 1, wherein one informs of the changes made on the work platform at prescribed time intervals.

36. A method according to claim 1, wherein one informs of the changes made on the work platform, when there is a predetermined number of changes made.

37. A method according to claim 1, wherein the work platform may be locked.

38. A system for working in a distributed working environment comprising:
a terminal device which comprises a client program;
a server which comprises a server program;
a telecommunication connection between the terminal device and the server, wherein the system further comprises:
means for using a multidimensional work platform saved on the server from the terminal device;
means for generating a multidimensional work platform; and
means for editing a multidimensional matrix.

39. The system according to claim 38, wherein the system comprises means for physically sending the work platform to a terminal device connected to the telecommunication network.

40. The system according to claim 39, wherein the system comprises means for sending the work platform to a wireless terminal device.

41. The system according to claim 38, wherein the system further comprises:
means for receiving a control e-mail message;
means for performing a function comprising a control e-mail message; and
means for compiling a feedback on the control function and sending it to the terminal device.

42. The system according to any of claim 38, wherein the system comprises a server for carrying out the program codes.

43. The system according to claim 38, wherein the system comprises a server for transmitting the work platform views to the user's terminal device.

44. The system according to claim 38, wherein as the server transmitting work platform views to the terminal device of the user functions the WWW server.

45. The system according to claim 38, wherein stored on the server is the information of the users and the views.

46. The system according to claim 38, wherein the server is arranged to retrieve the information of the users and the views from an external information system.
